(19) United States
(12) Patent Application Publication
(10) Pub. No.: US 2004/0093288 A1
(43) Pub. Date: May 13, 2004

(54) Methods and systems for pricing an inventory unit

(76) Inventors: Russell L. Strothmann, Broken Arrow, OK (US); Dianne R. McQuarrie, Tulsa, OK (US)

Correspondence Address: Finnegan, Henderson, Farabow,, Garrett & Dunner, L.L.P., 1300 I Street, N.W., Washington, DC, 20005-3315, US

(21) Appl. No.: 10/291,485

(22) Filed: Nov. 12, 2002

(51) Int. Cl. G06F 17/60

(52) U.S. Cl. 705/29

(57) ABSTRACT

Pricing an inventory unit includes receiving inventory data corresponding to the inventory unit and analyzing the inventory data to determine a dynamic market condition for the inventory unit. In addition, pricing an inventory unit further includes setting a sales price for the inventory unit based upon the dynamic market condition. Moreover, pricing an inventory unit may further include offering the inventory unit for sale at the sales price or setting a sales commission for the inventory unit based upon the dynamic market condition. In addition, pricing the inventory unit may include a framework for managing multiple criteria and objectives in determining an appropriate response to a dynamic market condition.

### TECHNICAL FIELD

The present invention relates to the field of pricing an inventory unit. More particularly, the present invention, in various specific embodiments, involves methods and systems directed to dynamically pricing an inventory unit.

### BACKGROUND

The Internet has been hailed the marketplace of the future, a result of its accessibility and usability. A computer equipped with a communication mechanism such as a modem and telephone connection is nearly all that is necessary to gain access to the Internet. A program called a browser, such as the Netscape Navigator from Netscape Corporation, makes it a simple task to traverse the vast network of information available on the Internet and, specifically, its subpart known as the “World Wide Web.”

The architecture of the Web follows a conventional client-server model.

The terms “client” and “server” are used to refer to a computer's general role as a requester of data (the client) or provider of data (the server). Under the Web environment, Web browsers reside in clients and specially formatted “Web documents” reside on Internet (Web) servers. Web clients and Web servers communicate using a conventional protocol called “HyperText Transfer Protocol” (HTTP).

In operation, a browser opens a connection to a server and initiates a request for a document. The server delivers the requested document, typically in the form coded in a standard such as the “HyperText Markup Language” (HTML) format. After the document is delivered, the connection is closed. The browser displays the document or performs a function designated by the document.

Every day, more people gain access to the Web, and every day, more of them are shopping online. Online shopping provides a level of convenience they want, need and will soon demand. Electronic commerce or “e-commerce” is the term often used to refer, at least in part, to online shopping on the Web. E-commerce is a unique opportunity for businesses of any size. E-commerce can expand a company's marketplace and consequently, its customer database. By simply providing a Web server having information on the company's product offerings and a customer database, and linking the Web server to the Web, the company can track visits, sales, buying trends and product preferences all at the customer level. The company can then present its customers with products they are most likely to buy on an individual basis. For this reason alone, many marketing professionals consider the Web to be one of the best direct marketing tools.

But the number of retailers with online stores is growing exponentially every year, making it increasingly difficult for online shoppers to navigate the Web to locate particular products at the best prices. This challenge for consumers also introduces a problem for merchants in designing campaigns to attract consumers to the merchants' Web sites and away from their competitors' sites.

Many Web sites provide consumers with access to goods and services of multiple suppliers. Suppliers set the prices and when consumers seek price information on products and services, the set prices are provided. One problem with this approach is that it prevents competitors (suppliers) for the consumer's business from addressing changes in the present state of the market. It is entirely possible that the supplier may wish to reprice products and services due to some change in the present state of the market, but is not able to do so using conventional technology.

Therefore, there is a need for a system that provides suppliers with the ability to compete more effectively in delivering products and services to consumers at competitive prices.

### SUMMARY OF THE INVENTION

Consistent with the present invention, methods and systems for pricing an inventory unit are provided that avoid problems associated with prior methods and systems for pricing an inventory unit.

In one aspect, a method for pricing an inventory unit comprises receiving inventory data corresponding to the inventory unit, analyzing the inventory data to determine a dynamic market condition for the inventory unit, and setting a sales price for the inventory unit based upon the dynamic market condition.

In another aspect, a system for pricing an inventory unit comprises a component for receiving inventory data corresponding to the inventory unit, a component for analyzing the inventory data to determine a dynamic market condition for the inventory unit, and a component for setting a sales price for the inventory unit based upon the dynamic market condition.

In yet another aspect, a computer-readable medium on which is stored a set of instructions for pricing an inventory unit, which when executed perform stages comprising receiving inventory data corresponding to the inventory unit, analyzing the inventory data to determine a dynamic market condition for the inventory unit, and setting a sales price for the inventory unit based upon the dynamic market condition.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of a system for pricing an inventory unit consistent with an embodiment of the present invention;

FIG. 2 is a functional block diagram of a computer network containing a client system and a server system consistent with an embodiment of the present invention;

FIG. 3 illustrates the retrieval of remote image and text and their integration in a document consistent with an embodiment of the present invention;

FIG. 4 is a flow chart of an exemplary method for pricing an inventory unit consistent with an embodiment of the present invention;

FIG. 5 is a flow chart of an exemplary subroutine used in the exemplary method of FIG. 4 for analyzing the inventory data consistent with an embodiment of the present invention;

FIG. 6 illustrates the results of a sales price calculation of a cruise reflecting dynamic market conditions consistent with an embodiment of the present invention;

FIG. 7 illustrates the results of a sales price calculation of a cruise reflecting dynamic market conditions consistent with an embodiment of the present invention;

FIG. 8 illustrates the results of a sales price calculation of a cruise reflecting dynamic market conditions consistent with an embodiment of the present invention;

FIG. 9 illustrates the results of a sales price calculation of a cruise reflecting dynamic market conditions consistent with an embodiment of the present invention; and

FIG. 10 illustrates the results of a sales price calculation of a cruise reflecting dynamic market conditions consistent with an embodiment of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with the general principles of the present invention, a system for pricing an inventory unit comprises a component for receiving inventory data corresponding to the inventory unit, a component for analyzing the inventory data to determine a dynamic market condition for the inventory unit, and a component for setting a sales price for the inventory unit based upon the dynamic market condition. Moreover, the system for pricing an inventory unit may further comprise at least one of a component for offering the inventory unit for sale at the sales price and a component for setting a sales commission for the inventory unit based upon the dynamic market condition.

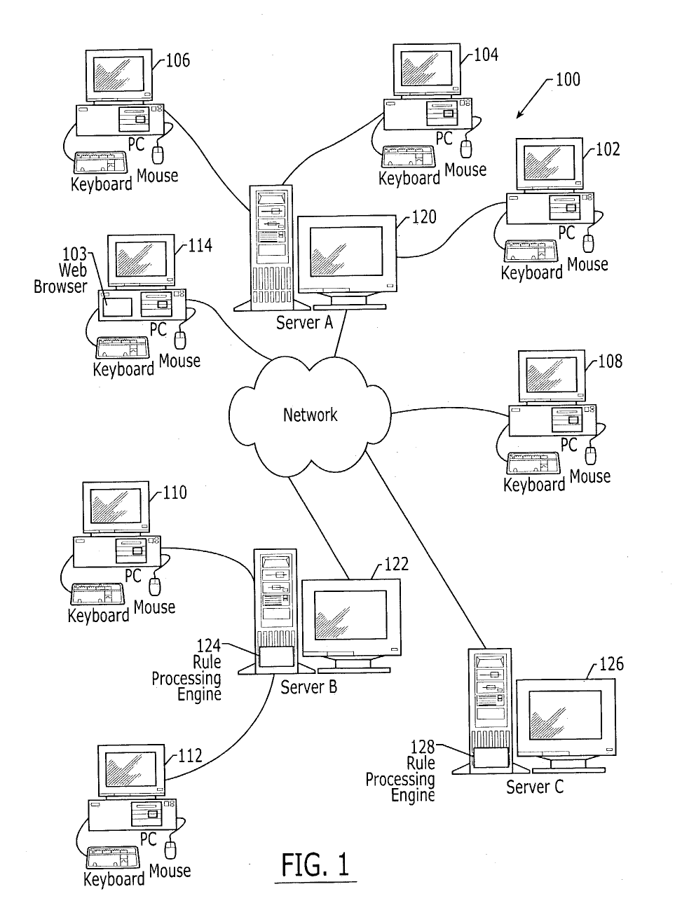

The component for receiving inventory data, the component for analyzing the inventory data, the component for setting a sales price for the inventory unit, the component for offering the inventory unit for sale, and the component for setting a sales commission may comprise elements of, be disposed within, or may otherwise be utilized by or embodied within the following: any or all of the systems as described in FIGS. 1-3 below, a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device that may receive, transmit, and/or process information. The above list of devices are exemplary and the component for receiving inventory data, the component for analyzing the inventory data, the component for setting a sales price for the inventory unit, the component for offering the inventory unit for sale, and the component for setting a sales commission may comprise elements of, be disposed within, or may otherwise be utilized by or embodied within many other devices or system without departing from the scope and spirit of the invention.

FIG. 1 illustrates a conceptual diagram of a computer network 100, such as the Internet. Computer network 100 comprises small computers (such as computers 102, 104, 106, 108, 110 and 112) and large computers (such as servers 120, 122 and 126). In general, small computers are “personal computers” or workstations and are the sites at which a human user operates the computer to make requests for data from other computers or servers on the network. Usually, the requested data resides in large computers. In this scenario, small computers are clients and the large computers are servers.

In this specification, the terms “client” and “server” are used to refer to a computer's general role as a requester of data (client) or provider of data (server). In general, the size of a computer or the resources associated with it do not preclude the computer's ability to act as a client or a server. Further, each computer may request data in one transaction and provide data in another transaction, thus changing the computer's role from client to server, or vice versa.

A client, such as computer 102, may request a file from server A 120. Since computer 102 is directly connected to server A 120, for example, through a local area network, this request would not normally result in a transfer of data over what is shown as the “network” of FIG. 1. The “network” of FIG. 1 represents, for example, the Internet, which is an interconnection of networks. A different request from computer may be for a file that resides in server B 122. In this case, the data is transferred from server B 122 through the network to server A 120 and, finally, to computer 102. The distance between server A 120 and server B 122 may be very long, e.g., across continents, or very short, e.g., within the same city. Further, in traversing the network, the data may be transferred through several intermediate servers and many routing devices, such as bridges and routers.

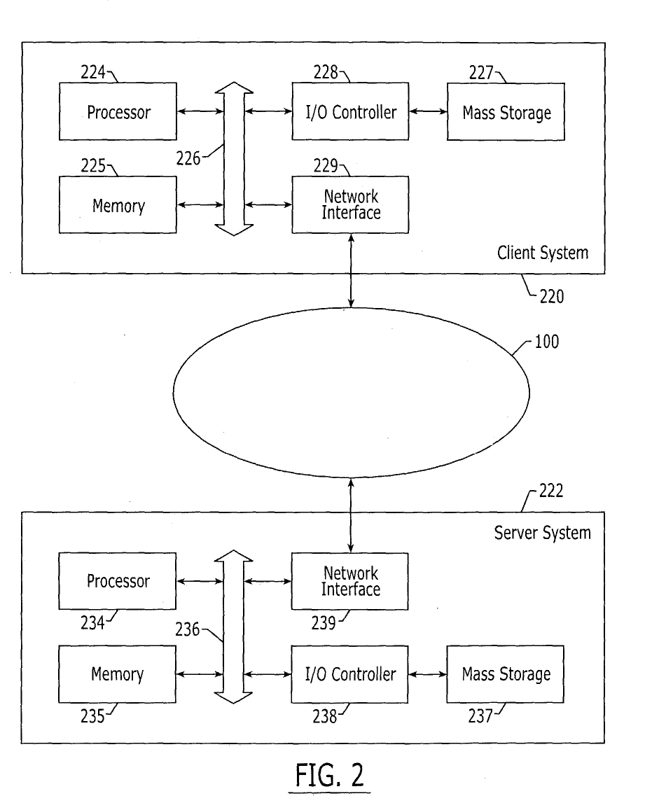

FIG. 2 shows, in more detail, an example of a client-server system interconnected through network 100. In this example, a server system 222 is interconnected through network 100 to client system 220. Client system 220 includes conventional components such as a processor 224, memory 225 (e.g. RAM), a bus 226 which couples processor 224 and memory 225, a mass storage device 227 (e.g. a magnetic hard disk or an optical storage disk) coupled to processor 224 and memory 225 through an I/O controller 228, and a network interface 229, such as a conventional modem.

Server system 222 also includes conventional components such as a processor 234, memory 235 (e.g. RAM), a bus 236 which couples processor 234 and memory 235, a mass storage device 237 (e.g. a magnetic or optical disk) coupled to processor 234 and memory 235 through an I/O controller 238, and a network interface 239, such as a conventional modem. It will be appreciated from the description below that the present invention may be implemented in software which is stored as executable instructions on a computer readable medium on the client and server systems, such as mass storage devices 227 and 237 respectively, or in memories 225 and 235 respectively.

The Internet consists of a worldwide computer network that communicates using a well defined protocol known as the Internet Protocol (IP). Computer systems that are directly connected to the Internet each have an unique address consisting of four numbers separated by periods such as “192.101.0.3”. To simplify Internet addressing, a “Domain Name System” was created that allows users to access Internet resources with a simpler alphanumeric naming system. For example, the name “travelocity.com” is the name for a computer operated by SABRE Inc.

To further define the addresses of resources on the Internet, a Uniform Resource Locator system was created that uses a Uniform Resource Locator (URL) as a descriptor that specifically defines a type of Internet resource and its location. URLs have the following format: “resou rce-type://domain.address/path-name.” The “resource-type” defines the type of Internet resource. Web documents, for example, are identified by the resource type “http”, which indicates the protocol used to access the document.

To access a document on the Web, the user enters a URL for the Web document into a browser program executed on a client, such as client system 220, with a connection to a network 100, such as the Internet. The Web browser then sends a request in accordance with the HTTP protocol to a Web server, such as server system 222, that has the Web document using the URL. The Web server responds to the request by transmitting the requested object to the client. In most cases, the object is a plain text document containing text (in ASCII) that is written in HTML. Such objects often contain hyperlinks to other Web documents. The Web browser displays the document on the screen for the user and the hyperlinks to other Web documents are emphasized in some fashion such that the user can selected the hyperlink.

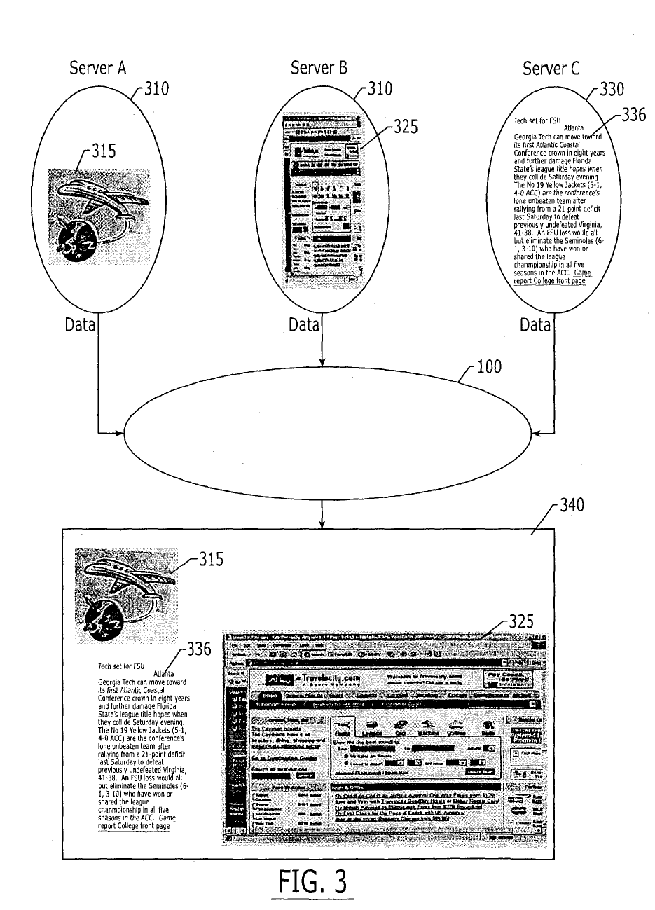

In some instances, the HTML document may contain data from more than one server. For example, FIG. 3 illustrates the retrieval of remote text and images, and their integration in a Web document by a client system 340. In FIG. 3, server A 310 contains an image 315, server B 320 contains a combination of text and image data 325 and server C 330 contains text data 336. Each of these servers is remotely located from the other servers and client 340. The transfer of data is via network 100. It should be appreciated that the text 336 and image 315 could be located in the same server which is remote from client 340.

Different techniques are available to display these types of composite Web documents. For example, a program called a servlet executing on one of the servers may combine data from the various servers referenced in a selected Web document and transmit the composite Web document to the client. In other configurations, the client may utilize a program called an applet, which may be transmitted to the client from one of the servers, to access the multiple servers offering parts of the composite and to build the composite Web document.

An exemplary embodiment of the present invention will be described utilizing the network architecture of FIGS. 1 and 2. In the exemplary embodiment of the present invention, a customer using client 114 and web browser 103 may type in the Uniform Resource Locator (URL) for a supplier's web server, which may be server B 122 of FIG. 1.

The web browser may send a request in accordance with the HTTP protocol to web server B 122 to retrieve the web document using the URL. Web server B 122 may respond by transmitting the web document to client 114. Once the customer receives the web document on the web browser 103, the customer may enter a request into the web document.

The web browser may then submit the request to web server B 122, web server B 122 may process the request by: (1) using recently acquired information stored in cache or information acquired through a batch process and rule processing engine 124; (2) submitting a request to a server, such as Server C 126, operated by a product or service provider for processing on rule processing engine 128; and/or (3) requesting price information from a server, such as Server C 126, operated by a product or service provider, and processing the received information on rule processing engine 124 (server B 122).

After rule processing engine (124 and 128) process the request by applying the supplier's business rules, a response may be returned through server B 122 to web browser 103. Web browser 103 may present the customer with the response which includes the most competitive price the supplier is willing to offer for the particular request.

It is important to note that this exemplary embodiment is not limited to the request being processed for or by only one supplier. The request may be processed in web server B 122 for a number of product or service providers and/or the request may be submitted to a number of servers, such as server C 126, for processing on the individual product or service provider's computer system.

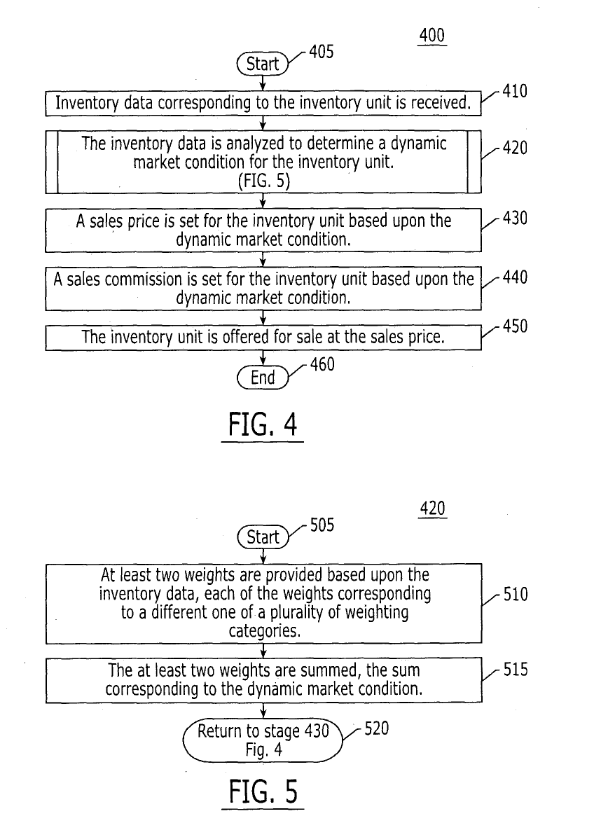

FIG. 4 is a flow chart setting forth the general stages involved in an exemplary method 400 for pricing an inventory unit consistent with an embodiment of the present invention. The implementation of the stages of exemplary method 400, in accordance with exemplary embodiments of the present invention, will be described in greater detail in FIGS. 5 through 10.

Exemplary method 400 begins at starting block 405 and proceeds to stage 410 where inventory data corresponding to the inventory unit is received. For example, the inventory unit may comprise at least one of a cruise, air transportation, hotel accommodations, a rental vehicle, and condominium accommodations. The inventory data may include at least one of commission discounts, risk inventory position, minimum acceptable wholesale price, competitor's inventory, upgrade allowance, seasonality, destination, and vendor. Upgrade allowance may be the ability to sell a higher category of cabin, room, or car at the merchant price of a lower category. Commission discount may be the percentage amount the travel provider will give to the merchant off the generally available selling price. For example, if a generally available price is $1000 and the travel provider may allow a 25% discount, the merchant price that may be paid to the travel provider is $750.00. Risk position may be an actual pre-purchase of the inventory from the seller. Specifically, if the merchant does not sell that inventory to the consumer, the money paid for the pre-purchase may be lost. For example, many sellers may buy blocks of cruise cabins or hotel rooms at a contract rate and then sell them to a consumer at a market rate. If the inventory goes unsold, the amount already paid to the travel may be lost. If the inventory unit comprises a cruise, the inventory data may comprise at least one of cabin class inventory availability, days until sailing, ship name, departure port, departure date, arrival port, and arrival date. The aforementioned inventory units and inventory data are exemplary and other elements may comprise the inventory units and inventory data.

The inventory data may be provided by a vendor of the inventory unit. The vendor may comprise a cruise line operator, airline operator, or a hotel operator. In addition to, or in conjunction with the system or systems of FIGS. 1-3 as defined above, the inventory data may be received using at least one of regular mail, e-mail, facsimile, internet, a network, and an interactive voice response system. The aforementioned systems and processes for receiving the inventory data are exemplary and other systems and processes may be employed. Furthermore, the aforementioned list of vendors is exemplary and subjects other than the vendor may provide the inventory data.

From stage 410 where the inventory data corresponding to the inventory unit is received, exemplary method 400 advances to exemplary subroutine 420 where the inventory data is analyzed to determine a dynamic market condition for the inventory unit. The stages of exemplary subroutine 420 are shown in FIG. 5 and will be described in greater detail below.

After the inventory data is analyzed to determine the dynamic market condition for the inventory unit in exemplary subroutine 420, exemplary method 400 continues to stage 430 where a sales price is set for the inventory unit based upon the dynamic market condition. For example, setting the sales price for the inventory unit based upon the dynamic market condition may comprise establishing the sales price in proportion to the sum of weights, which are described in detail below with respect to FIG. 5.

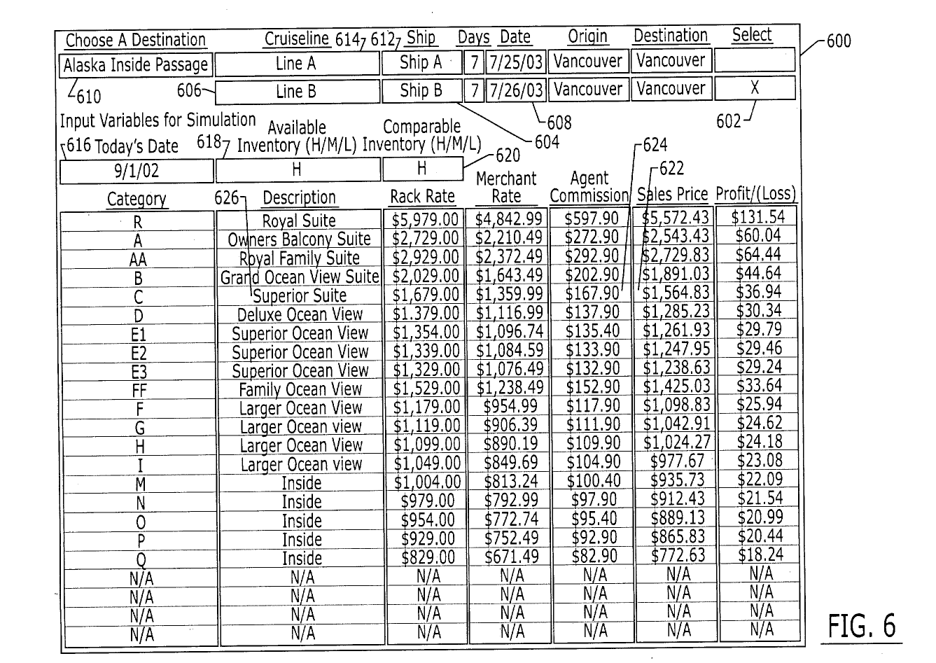

Specifically, if dynamic market condition, as reflected by the sum of the weights, is at its highest level, the inventory unit sales price may be set at a maximum value. However, if the dynamic market condition, as reflected by the sum of the weights, is at its lowest level, the inventory unit sales price may be set at a minimum value. Furthermore, the inventory unit sales price may be scaled in proportion to the dynamic market condition, as reflected by the sum of the weights, between a maximum and minimum value by any scaling technique. The sales price may be established in proportion to the sum of the weights through the intervention of a subject, such as a business analyst, or it may be established by a computer programming module applying, for example, a rules base. FIG. 6-10, as described below, illustrate sales price establishment using the dynamic market condition.

Once the sales price is set for the inventory unit based upon the dynamic market condition in stage 430, exemplary method 400 proceeds to stage 440 where a sales commission is set for the inventory unit based upon the dynamic market condition. For example, the sales commission, payable to a travel agent for example, may be a set percentage of the inventory unit sales price. The set percentage may comprise, but not limited to, 5% to 15% of the inventory unit sales price. In this case, because the sales commission may be based upon the inventory unit sales price, which may itself be based upon the dynamic market condition, the sales commission may thus be based upon the dynamic market condition. The sales commission may be established through the intervention of a subject, such as a business analyst, or it may be established by a computer programming module applying, for example, a rules base. Notwithstanding, the sales commission may based on factors other than the dynamic market condition.

From stage 440 where the sales commission is set for the inventory unit based upon the dynamic market condition, exemplary method 400 advances to stage 450 where the inventory unit is offered for sale at the sales price. For example, in addition to or in conjunction with the system or systems of FIGS. 1-3, the inventory unit may be offered for sale using at least one of regular mail, e-mail, facsimile, internet, a network, and an interactive voice response system. The aforementioned systems and processes for offering the inventory unit for sale are exemplary and other systems and processes may be employed. After the inventory unit is offered for sale at the sales price in stage 450, exemplary method 400 ends at stage 460.

FIG. 5 describes exemplary subroutine 420 from FIG. 4 for analyzing the inventory data. Exemplary subroutine 420 begins at starting block 505 and advances to stage 510 where at least two weights are provided based upon the inventory data, each of the weights corresponding to a different one of a plurality of weighting categories. For example, the plurality of weighting categories may comprise cruise line, cruise ship, cabin grade, cabin inventory, destination, departure port, arrival port, days till departure, and available inventory on other ships similar to the inventory unit. The aforementioned weighting categories are exemplary and other weighting categories may be used.

If the desired departure date is more than one year away, for example, a weight of five points may be assigned to a corresponding weighting category. If the desired departure date is less than one month, however, a weight of one point may be assigned to this weighting category. Furthermore, if the available inventory is high, a weight of one point may be assigned to a corresponding weighting category. If the available inventory is low, however, a weight of five points may be assigned to this weighting category. Weights may be provided by, for example, a business analyst or through a computer programming module.

Cruise lines, for example, may not consider their products as equal with their competitors. When the inventory unit comprises a cruise, embodiments of the present invention may incorporate a leveling technique that assigns a ship category of luxury, mid-range, or mass market that can be used to assign a ship's specific point value. Also, there may be categories within a given ship that do not readily track from one cruise line to another. Cabin grades, within embodiments of the present invention, may be assigned a value of 1-12 to define a level of similarity from one ship to another. For example, 1 may be a luxury penthouse suite, where 12 may be the most economical mass market cabin. This may allow a cabin-to-cabin and ship-to-ship competitive comparison.

After the at least two weights are provided based upon the inventory data, each of the weights corresponding to a different one of a plurality of weighting categories in stage 510, exemplary subroutine 420 continues to stage 515 where the at least two weights are summed, the sum corresponding to the dynamic market condition. Using the aforementioned examples as described with respect to stage 510 above, if the available inventory is high (1 point) and the desired departure date is less than one month (1 point), the sum of the weights corresponding to the dynamic market condition may comprise 2 points. If the available inventory is high (1 point) and the desired departure date is more than one year away (5 points), the sum of the weights corresponding to the dynamic market condition may comprise 6 points.

Once the two or more weights are summed, the sum corresponding to the dynamic market condition, in stage 515, exemplary subroutine 420 proceeds to stage 520 and returns to stage 430 of FIG. 4.

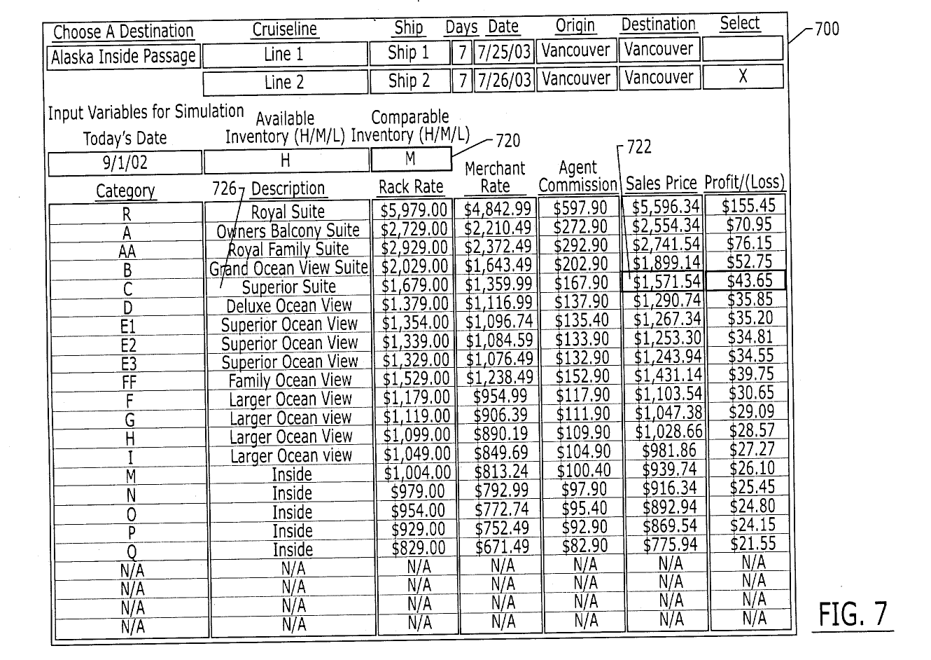

FIG. 6 shows a spreadsheet 600 illustrating, for example, the sales price of a cruise reflecting the dynamic market conditions. The “X” in selection box 602 indicates ship B 604 of cruise line B 606 has a departure date 608 to destination 610. Ship A 612 on cruise line A 614 includes an inventory comparable to ship B 604. Given a today's date 616, a high available inventory 618 on ship 604, and a high comparable inventory 620 on ship 612, a sales price 622 of $1,564,83 and an agents commission 624 of $167.9 may be calculated for cabin grade “superior suite” 626 using exemplary method 400. As shown in FIG. 7-10, the sales price may change to reflect changing dynamic market conditions.

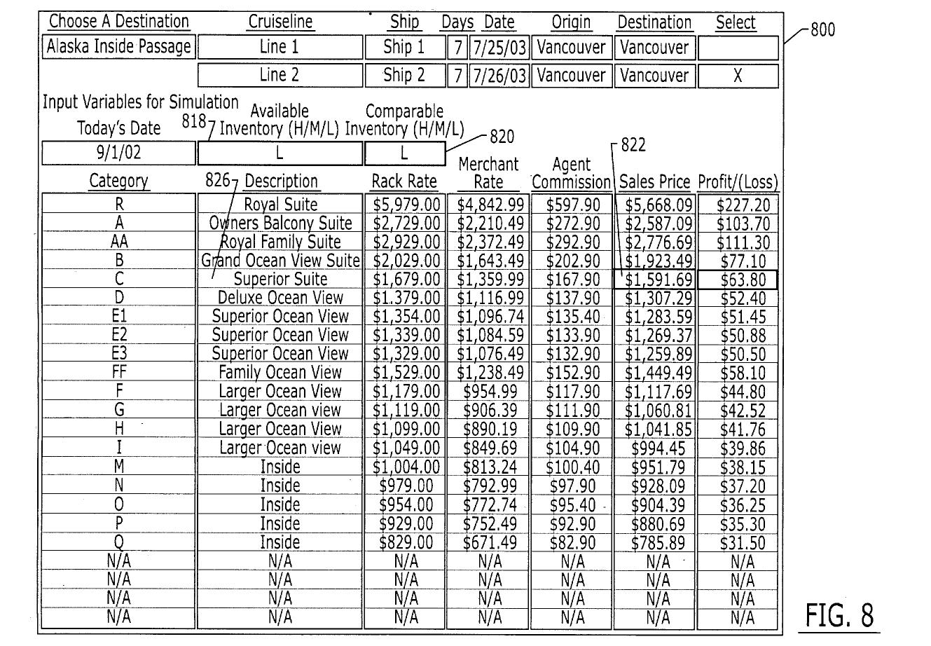

As shown in spreadsheet 700 of FIG. 7, given an update of the inventory data, the high comparable inventory 620 on ship 612 of FIG. 6 changed to a medium comparable inventory 720. With a corresponding change in the dynamic market condition, exemplary method 400 may recalculate a sales price 722 of $ 1,571.54 for cabin grade “superior suite” 726 . Similarly, as shown in spreadsheet 800 of FIG. 8, given an update of the inventory data, a low available inventory 818 and a low comparable inventory 820 may now exist. This may cause exemplary method 400 to recalculate a sales price 822 of $ 1,591.69 for cabin grade “superior suite” 826.

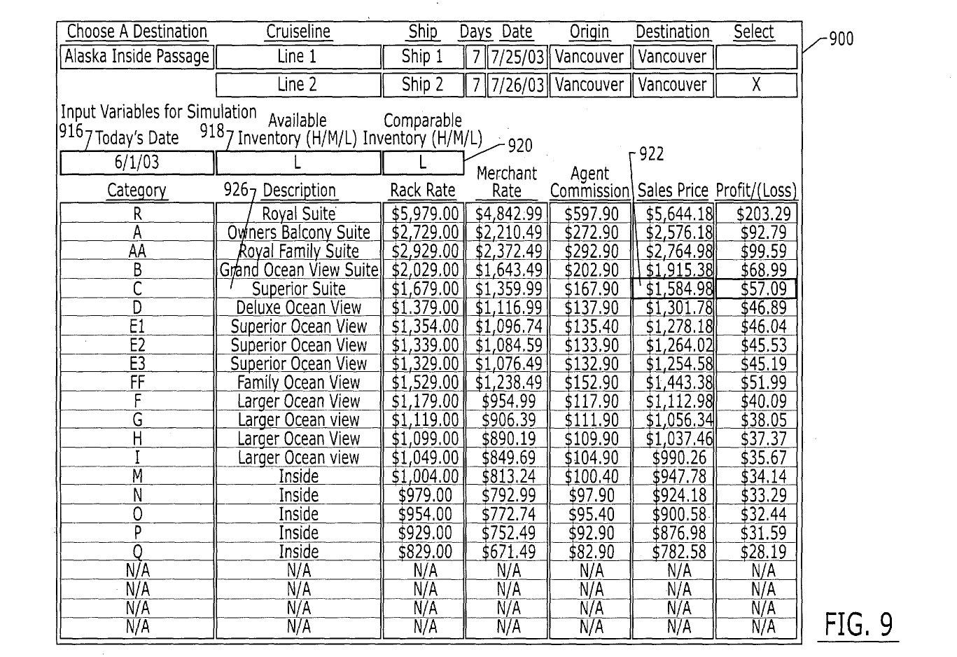

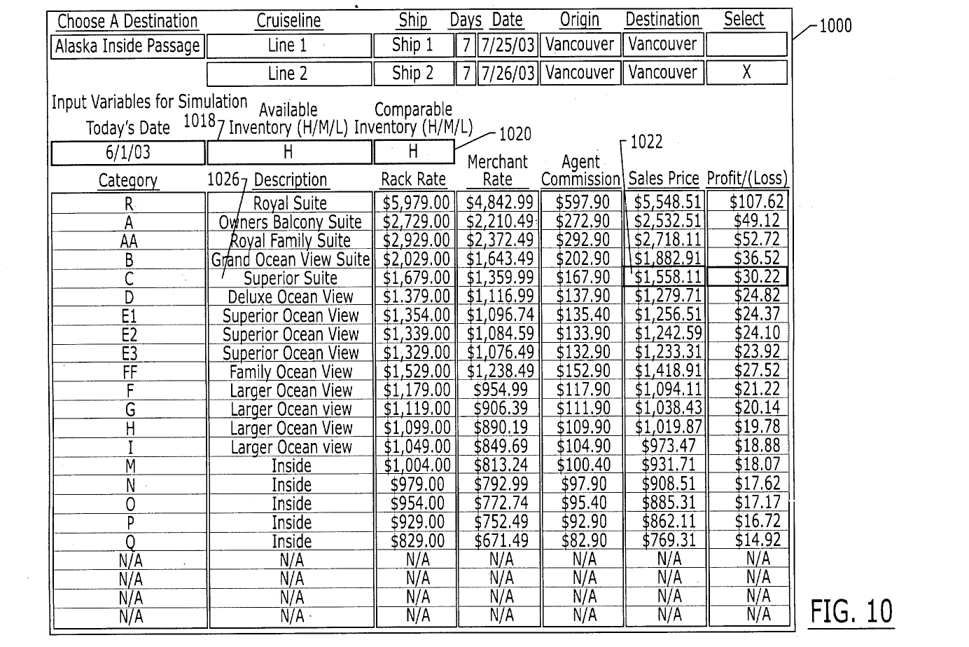

As shown in spreadsheet 900 of FIG. 9, given a today's date 916 that is much closer to the departure date, and maintaining a low available inventory 918 and a low comparable inventory 920, exemplary method 400 may recalculate a sales price 922 of $ 1,584.98 for cabin grade “superior suite” 926. Again, a change in the dynamic market condition is reflected. However, if a high available inventory 1018 and a high comparable inventory 1020 are present, as shown in spreadsheet 1000 of FIG. 10, with the other factors remaining constant, exemplary method 400 may recalculate a sales price 1022 of $ 1,558.11 for cabin grade “superior suite” 1026.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for pricing an inventory unit comprising:
receiving inventory data corresponding to the inventory unit;
analyzing the inventory data to determine a dynamic market condition for the inventory unit; and
setting a sales price for the inventory unit based upon the dynamic market condition.

2. The method for pricing the inventory unit of claim 1, wherein the inventory data is provided by a vendor of the inventory unit.

3. The method for pricing the inventory unit of claim 1, wherein the inventory unit comprises at least one of a cruise, air transportation, hotel accommodations, a rental vehicle, and condominium accommodations.

4. The method for pricing the inventory unit of claim 3, wherein if the inventory unit comprises a cruise, the inventory data comprises at least one of cabin class inventory availability, days until sailing, ship name, departure port, departure date, arrival port, and arrival date.

5. The method for pricing the inventory unit of claim 1, wherein the inventory data comprises at least one of commission discounts, risk inventory position, minimum acceptable wholesale price, competitor's inventory, seasonality, destination, upgrade allowance, and vendor.

6. The method for pricing the inventory unit of claim 1, wherein the inventory data is received using at least one of regular mail, e-mail, facsimile, internet, a network, and an interactive voice response system.

7. The method for pricing the inventory unit of claim 1, wherein analyzing the inventory data to determine the dynamic market condition for the inventory unit further comprises:
providing at least two weights based upon the inventory data, each of the weights corresponding to a different one of a plurality of weighting categories; and
summing the at least two weights, the sum corresponding to the dynamic market condition.

8. The method for pricing the inventory unit of claim 7, wherein the plurality weighting categories comprise cruise line, cruise ship, cabin grade, cabin inventory, destination, departure port, arrival port, days till departure, and available inventory on other ships similar to the inventory unit.

9. The method for pricing the inventory unit of claim 7, wherein setting the sales price for the inventory unit based upon the dynamic market condition further comprises establishing the sales price in proportion to the sum of the weights.

10. The method for pricing the inventory unit of claim 1, further comprising offering the inventory unit for sale at the sales price.

11. The method for pricing the inventory unit of claim 10, wherein the inventory unit is offered for sale using at least one of regular mail, e-mail, facsimile, internet, a network, and an interactive voice response system.

12. The method for pricing the inventory unit of claim 1, further comprising setting a sales commission for the inventory unit based upon the dynamic market condition.

13. A system for pricing an inventory unit comprising:
a component for receiving inventory data corresponding to the inventory unit;
a component for analyzing the inventory data to determine a dynamic market condition for the inventory unit; and
a component for setting a sales price for the inventory unit based upon the dynamic market condition.

14. The system for pricing the inventory unit of claim 13, wherein the inventory data is provided by a vendor of the inventory unit.

15. The system for pricing the inventory unit of claim 13, wherein the inventory unit comprises at least one of a cruise, air transportation, hotel accommodations, a rental vehicle, and condominium accommodations.

16. The system for pricing the inventory unit of claim 15, wherein if the inventory unit comprises a cruise, the inventory data comprises at least one of cabin class inventory availability, days until sailing, ship name, departure port, departure date, arrival port, and arrival date.

17. The system for pricing the inventory unit of claim 13, wherein the inventory data comprises at least one of commission discounts, risk inventory position, minimum acceptable wholesale price, competitor's inventory, seasonality, destination, upgrade allowance, and vendor.

18. The system for pricing the inventory unit of claim 13, wherein the inventory data is received using at least one of regular mail, e-mail, facsimile, internet, a network, and an interactive voice response system.

19. The system for pricing the inventory unit of claim 13, wherein the component for analyzing the inventory data to determine the dynamic market condition for the inventory unit is further configured for:
providing at least two weights based upon the inventory data, each of the weights corresponding to a different one of a plurality of weighting categories; and
summing the at least two weights, the sum corresponding to the dynamic market condition.

20. The system for pricing the inventory unit of claim 19, wherein the plurality weighting categories comprise cruise line, cruise ship, cabin grade, cabin inventory, destination, departure port, arrival port, days till departure, and available inventory on other ships similar to the inventory unit.

21. The system for pricing the inventory unit of claim 19, wherein the component for setting the sales price for the inventory unit based upon the dynamic market condition is further configured for establishing the sales price in proportion to the sum of the weights.

22. The system for pricing the inventory unit of claim 13, further comprising a component for offering the inventory unit for sale at the sales price.

23. The system for pricing the inventory unit of claim 10, wherein the inventory unit is offered for sale using at least one of regular mail, e-mail, facsimile, internet, a network, and an interactive voice response system.

24. The system for pricing the inventory unit of claim 13, further comprising a component for setting a sales commission for the inventory unit based upon the dynamic market condition.

25. A computer-readable medium on which is stored a set of instructions for pricing an inventory unit, which when executed perform stages comprising:
receiving inventory data corresponding to the inventory unit;
analyzing the inventory data to determine a dynamic market condition for the inventory unit; and
setting a sales price for the inventory unit based upon the dynamic market condition.

26. The computer-readable medium for pricing the inventory unit of claim 25, wherein the inventory data is provided by a vendor of the inventory unit.

27. The computer-readable medium for pricing the inventory unit of claim 25, wherein the inventory unit comprises at least one of a cruise, air transportation, hotel accommodations, a rental vehicle, and condominium accommodations.

28. The computer-readable medium for pricing the inventory unit of claim 27, wherein if the inventory unit comprises a cruise, the inventory data comprises at least one of cabin class inventory availability, days until sailing, ship name, departure port, departure date, arrival port, and arrival date.

29. The computer-readable medium for pricing the inventory unit of claim 25, wherein the inventory data comprises at least one of commission discounts, risk inventory position, minimum acceptable wholesale price, competitor's inventory, seasonality, destination, upgrade allowance, and vendor.

30. The computer-readable medium for pricing the inventory unit of claim 25, wherein the inventory data is received using at least one of regular mail, e-mail, facsimile, internet, a network, and an interactive voice response system.

31. The computer-readable medium for pricing the inventory unit of claim 25, wherein analyzing the inventory data to determine the dynamic market condition for the inventory unit further comprises:
providing at least two weights based upon the inventory data, each of the weights corresponding to a different one of a plurality of weighting categories; and
summing the at least two weights, the sum corresponding to the dynamic market condition.

32. The computer-readable medium of for pricing the inventory unit claim 31, wherein the plurality weighting categories comprise cruise line, cruise ship, cabin grade, cabin inventory, destination, departure port, arrival port, days till departure, and available inventory on other ships similar to the inventory unit.

33. The computer-readable medium for pricing the inventory unit of claim 31, wherein setting the sales price for the inventory unit based upon the dynamic market condition comprises establishing the sales price in proportion to the sum of the weights.

34. The computer-readable medium for pricing the inventory unit of claim 25, further comprising offering the inventory unit for sale at the sales price.

35. The computer-readable medium for pricing the inventory unit of claim 34, wherein the inventory unit is offered for sale using at least one of regular mail, e-mail, facsimile, internet, a network, and an interactive voice response system.

36. The computer-readable medium for pricing the inventory unit of claim 25, further comprising setting a sales commission for the inventory unit based upon the dynamic market condition.
